(19) United States
(12) Patent Application Publication
(10) Pub. No.: US 2009/0159823 A1
(43) Pub. Date: Jun. 25, 2009

(54) MECHANICAL VALVE

(75) Inventors: Hiroshi Matsunaga, Tokyo (JP); Atsushi Saito, Kuki-shi (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignees: TEAC Corporation, Tokyo (JP); Sony Corporation, Tokyo (JP)

(21) Appl. No.: 12/334,326

(22) Filed: Dec. 12, 2008

(30) Foreign Application Priority Data
Dec. 12, 2007 (JP) 2007-320904

(51) Int. Cl. F16K 31/02

(52) U.S. Cl. 251/129.15

(57) ABSTRACT

A mechanical valve has a main body having a cylinder hole formed therein, a movable element that is inserted into the cylinder hole and that moves forwardly and rearwardly, and a drive section that drives the movable element. A plurality of openings through which air passes are formed in an internal peripheral surface of the cylinder hole, and the openings are opened and closed as a result of forward and rearward movements of the movable element. A movable magnet is fastened to each of both ends of the movable element. Electromagnets opposing the respective movable magnets are provided in a drive section. The movable element is actuated by utilization of magnetic force of the electromagnets.

### PRIORITY INFORMATION

This application claims priority to Japanese Patent Application No. 2007-320904 filed on Dec. 12, 2007 which is incorporated herein by reference in its entirety.

### BACKGROUND

1. Technical Field

The present invention relates to a mechanical valve capable of switching between a first state in which the passage of first air is permitted and a second state where the passage of second air is permitted.

2. Related Art

A compact valve capable of being actuated at high speed has recently been sought. For instance, such a valve is used in an electronic component automatic placement machine that places electronic components on a printed circuit board. The electronic component automatic placement machine has a suction nozzle that holds an electronic component by suction. The suction nozzle is switchably supplied with negative-pressure air and positive-pressure air, thereby sucking a component and releasing the thus-sucked component. With a view toward switchably supplying the negative-pressure air and the positive-pressure air, a compact valve capable of being actuated at high speed has been called for.

In order to meet such a demand, JP 9-144911 A describes an air pressure switching mechanism for a suction nozzle including a negative pressure supply valve and a positive pressure supply valve that are integrated into a single piece, wherein rods acting as valve elements of the respective valves are alternately actuated. Further, JP 11-40989 A describes a mechanical valve that switches air pressure by vertically actuating a piston within a cylinder in which a negative pressure supply port and a positive pressure supply port are opened.

However, the air pressure switching mechanism described in JP 9-144911 A has a large number of components and encounters various problems, such as an increase in cost and complication of assembling operation. In JP 11-40989 A, a piston corresponding to a valve element is actuated by way of a motor, a cam-shaped arm, and the like. Therefore, there has been a problem of a mechanism for actuating the valve element being likely to become bulky. Moreover, an expensive motor must be prepared to realize high-speed actuation, which results in a problem of an increase in cost. In a word, a compact valve having a simple structure has never been available.

Accordingly, the present invention provides a compact mechanical valve having a simple structure.

### SUMMARY

A mechanical valve of the present invention includes a cylinder having a first air opening for permitting passage of first air and a second air opening for permitting passage of second air, both of which are formed in an internal peripheral surface of the cylinder; a shaft that is inserted into the cylinder so as to be movable in forward and rearward directions, that opens the first air opening and closes the second air opening by means of forward movement, and that opens the second air opening and closes the first air opening by means of rearward movement; and drive means that moves the shaft forwardly and rearwardly, wherein the drive means includes a pair of movable magnets that are formed from permanent magnets and that are provided at both ends of the shaft; a pair of electromagnets that are provided opposite the respective movable magnets and that forwardly and rearwardly moves the shaft by means of magnetic force developing between the electromagnet and a corresponding movable magnet when the electromagnets are excited; and a drive circuit for exciting the pair of electromagnets.

In a preferred mode, a magnetic core of each of the electromagnets is a magnet that induces magnetic repulsive force between the magnetic core and an opposing movable magnet. In another preferred mode, the magnetic core of each of the electromagnets is a magnetic pole formed from soft iron. In another preferred mode, the magnetic core of each of the electromagnets is a magnetic pole formed from a composite including soft iron and a magnet for biasing magnetic force. In another preferred mode, a magnetic material area, which is formed from a magnetic material and which works as a latch mechanism for regulating movement of the movable magnet by exhibiting magnetic attractive force between the movable magnet and the magnetic material area, is provided in the vicinities of at least both ends of the cylinder. In yet another preferred mode, the inside of the shaft is hollow.

In still another preferred mode, the first air opening includes a first air inlet for permitting entry of the first air and a first air outlet that is aligned with the first air inlet along a circumferential direction and that permits discharge of the first air; the second air opening includes a second air inlet for permitting entry of the second air and a second air outlet that is aligned with the second air inlet along the circumferential direction and that permits external discharge of the second air; and the shaft includes large-diameter portions that are essentially identical in size with an internal diameter of the cylinder, that close the second air inlet and the second air outlet at the time of forward movement of the shaft, and that close the first air inlet and the first air outlet at the time of rearward movement of the shaft; and a small-diameter portion that creates passage space for permitting passage of air between an internal peripheral surface of the cylinder and the small-diameter portion, that opens the first air inlet and the first air outlet at the time of forward movement of the shaft, and that opens the second air inlet and the second air outlet at the time of rearward movement of the shaft.

According to the present invention, switchable air supply becomes possible by driving one shaft by utilization of magnetic force. Therefore, a compact mechanical valve having a simple structure is acquired.

The invention will be more clearly comprehended by reference to the embodiment provided below. However, the scope of the invention is not limited to the embodiment.

### BRIEF DESCRIPTION OF THE DRAWINGS

A preferred embodiment of the present invention will be described in detail by reference to the following drawings, wherein:

FIG. 1 is a cross-sectional view of a mechanical valve corresponding to an embodiment of the present invention;

FIG. 2 is an exploded perspective view of a main body and a movable element;

FIG. 3 is a view of the main body achieved in a direction A of FIG. 2;

FIG. 4 is a cross-sectional view taken along line B-B in FIG. 3;

FIG. 5 is a cross-sectional view taken along line C-C in FIG. 3;

FIG. 6 is a cross-sectional view taken along line D-D in FIG. 3;

FIG. 7 is an exploded cross-sectional view of the movable element;

FIG. 8A is a view showing a portion of a drive circuit;

FIG. 8B is a view showing a remaining portion of the drive circuit;

FIG. 9 is a cross-sectional view of the principal section of the mechanical valve achieved at the time of supply of positive-pressure air; and

FIG. 10 is a cross-sectional view of the principal section of the mechanical valve achieved at the time of supply of negative-pressure air.

### DETAILED DESCRIPTION

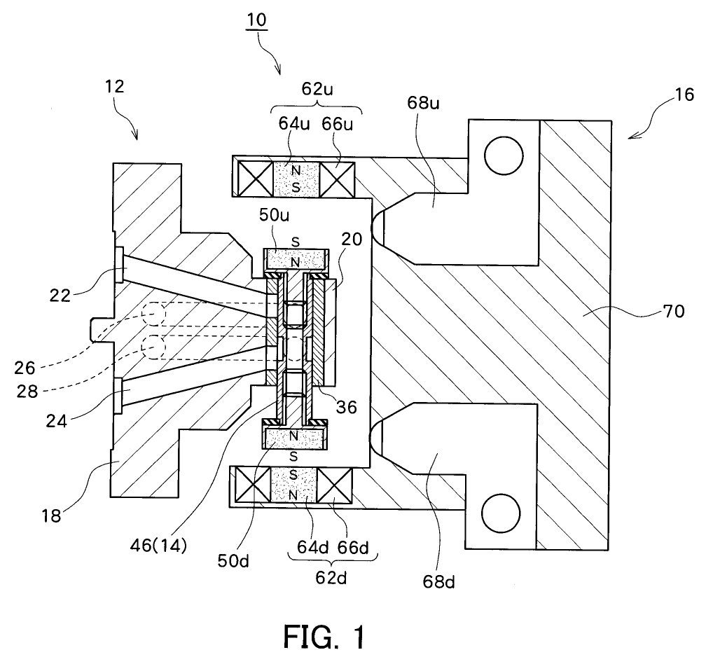

An embodiment of the present invention will be described hereunder by reference to the drawings. FIG. 1 is a cross-sectional view of a mechanical valve 10 of an embodiment of the present invention. The mechanical valve 10 is a valve assumed to be used in an electronic component automatic placement apparatus (not shown) that places electronic components on a circuit board. Specifically, the electronic component automatic placement apparatus is equipped with a head that can move in directions X, Y, and Z, and the head is equipped with a suction nozzle that holds an electronic component by suction. The mechanical valve 10 of the present embodiment is a valve for supplying switchably the suction nozzle with positive-pressure air or negative-pressure air.

The mechanical valve 10 is broadly divided into a main body 12 attached to a head of the electronic component automatic placement apparatus; a movable element 14 that moves forwardly and rearwardly with respect to the main body 12; and a drive section 16 for actuating the movable element 14. The drive section 16 causes magnetic force to act on the movable element 14, thereby moving the movable element 14 forwardly or rearwardly. As a result of forward or rearward movement of the movable element 14, inlets and outlets for various kinds of air opened in the main body 12 are blocked or opened, whereupon positive-pressure air and negative-pressure air are switchably supplied. The structure of the mechanical valve 10 will be described in detail hereunder.

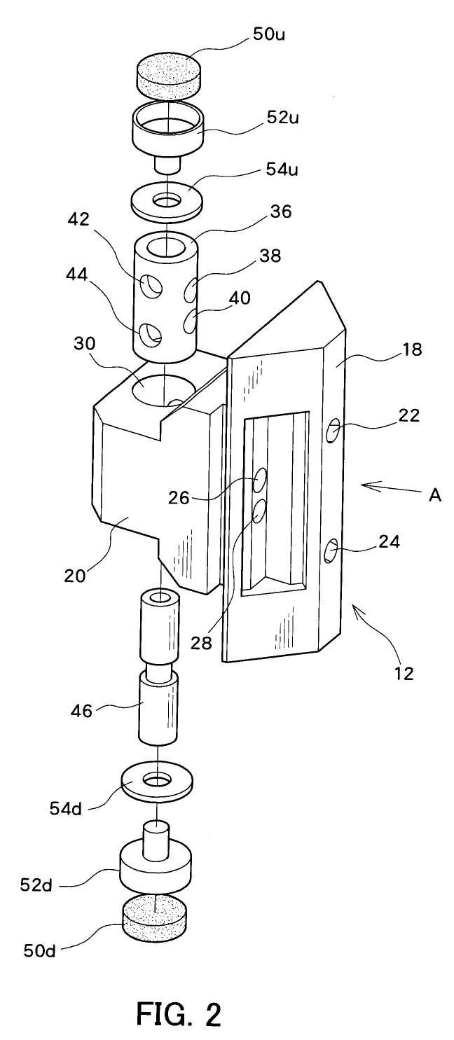

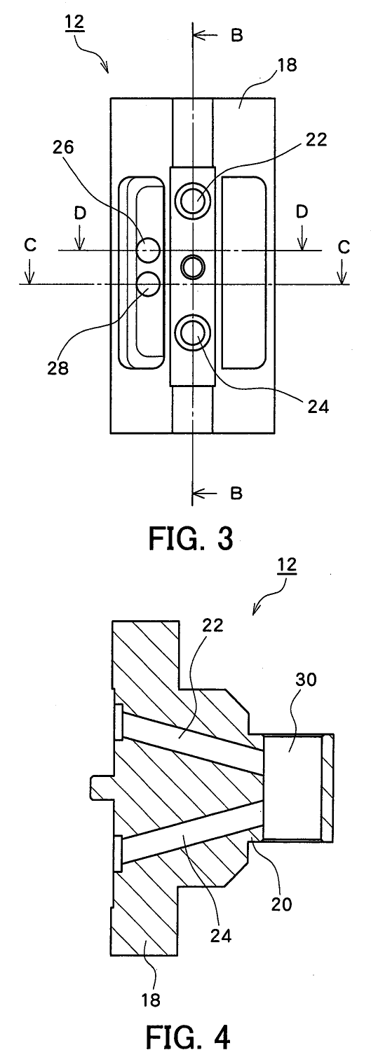

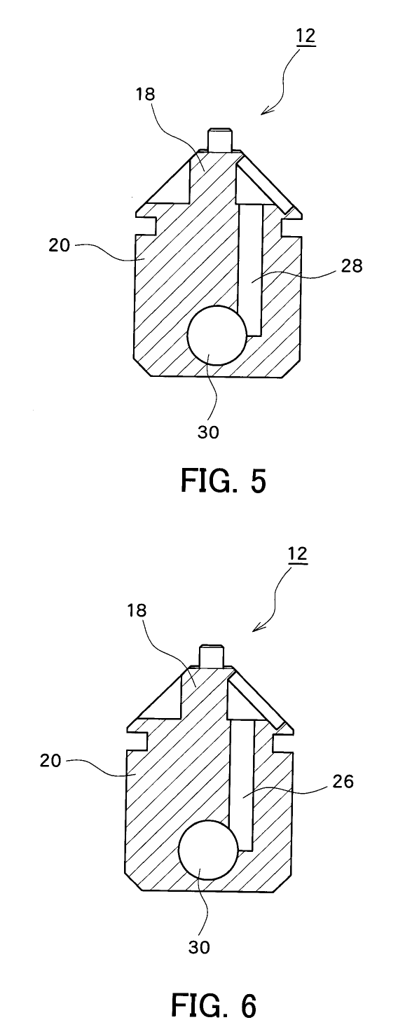

The structure of the main body 12 will first be described by reference to FIGS. 2 through 6. FIG. 2 is an exploded perspective view of the main body 12 and the movable element 14. FIG. 3 is a front view of the main body 12 (a view achieved in direction A of FIG. 2); FIG. 4 is a cross-sectional view taken along line B-B in FIG. 3; FIG. 5 is a cross-sectional view taken along line C-C in FIG. 3; and FIG. 6 is a cross-sectional view taken along line D-D in FIG. 3.

As mentioned previously, the main body 12 is a member attached to the head of the electronic component automatic placement apparatus. The main body 12 is made up of an engineering plastic-molded component, such as PC (polycarbonate), and a collar 36 made of a magnetic material, such as SUS440C. An attachment section 18 fastened to the head and a block-shaped cylinder section 20 are molded in a single piece. The attachment section 18 assumes the shape of an essential triangle pole corresponding to a mount groove (not shown) formed in the head, and the attachment section 18 is fastened to the head such that a side surface (slope) of the essentially-triangle pole comes into close contact with the side surface of the mount groove. The shape of the attachment section 18 is changed, as required, in conformity with the shape of the attachment groove formed in the head. Restrictions are not imposed on the shape of the attachment section.

Four passageways 22, 24, 26, and 28 extending toward a cylinder 20 are formed in the surface of the attachment section 18. A negative pressure entrance path 22 is a passageway (hole) connected to a negative pressure pump (not shown) that supplies negative-pressure air and guides the negative-pressure air supplied from the negative pressure pump to a cylinder hole 30 to be described later. A positive pressure entrance path 24 is a passageway connected to a positive pressure pump (not shown) that supplies positive-pressure air and guides the positive-pressure air supplied from the positive pressure pump to the cylinder hole 30. The negative pressure entrance path 22 and the positive pressure entrance path 24 are formed side by side along the vertical direction. As illustrated in FIG. 4, both of the paths extend up to the cylinder hole 30.

The negative pressure discharge path 26 is a passageway that is connected to the nozzle of the electronic component automatic placement apparatus and that guides to the nozzle negative-pressure air supplied to the cylinder hole 30. The positive pressure discharge path 28 is a passageway that is connected to the nozzle and that guides to the nozzle positive-pressure air supplied to the cylinder hole 30. The negative pressure discharge path 26 and the positive pressure discharge path 28 are formed side by side along the vertical direction, and both of the paths extend up to the cylinder hole 30 as shown in FIGS. 5 and 6.

As mentioned previously, the cylinder 20 is an area that is integrally molded along with the attachment section 18 and that assumes an essentially-block-shaped form. The cylinder hole 30 extending in the vertical direction (the direction of an axis of the attachment section having the shape of an essentially triangle pole) is opened in the cylinder 20. The cylinder hole 30 is a hole into which the movable element 14, which will be described later, is to be inserted, and a collar 36 for adjusting the size of the hole is inserted into the cylinder hole 30 (see FIG. 2). The collar 36 is made of a magnetic material and doubles also as a magnetic material section that operates as a latch mechanism for regulating movements of movable magnets 50u and 50d, which will be described later, by exhibiting magnetically-attractive force between the movable magnets 50u and 50d. An outer diameter of the collar 36 is essentially identical with the size of the cylinder hole 30. When the collar 36 is fitted to the cylinder hole 30, an exterior surface of the collar 36 and an interior surface of the cylinder hole 30 may come into close contact with each other.

Four holes 38, 40, 42, and 44 for bringing the foregoing two entrance paths 22 and 24, the two discharge paths 26 and 28, and the cylinder hole 30 into mutual communication are opened in the collar 36. The four holes 38, 40, 42, and 44 are placed at positions where they directly face the corresponding entrance paths 22 and 24 or the discharge paths 26 and 28 (to be more precise, communication paths 32 and 34 remaining in mutual communication with the discharge paths 26 and 28) when the collar 36 is attached to the cylinder hole 30. A positional relationship among the four holes 38, 40, 42, and 44 will now be described.

Among the four holes opened in the collar 36, the negative pressure inlet 38 corresponding to the negative pressure entrance path 22 and the positive pressure inlet 40 corresponding to the positive pressure entrance path 24 are formed side by side along the vertical direction. The negative pressure outlet 42 corresponding to the negative pressure discharge path 26 and the positive pressure outlet 44 corresponding to the positive pressure discharge path 28 are formed side by side along the vertical direction. Further, the negative pressure inlet 38 and the negative pressure outlet 42 are essentially adjacent to each other in a circumferential direction, and the positive pressure inlet 40 and the positive pressure outlet 44 are substantially adjacent to each other in the circumferential direction.

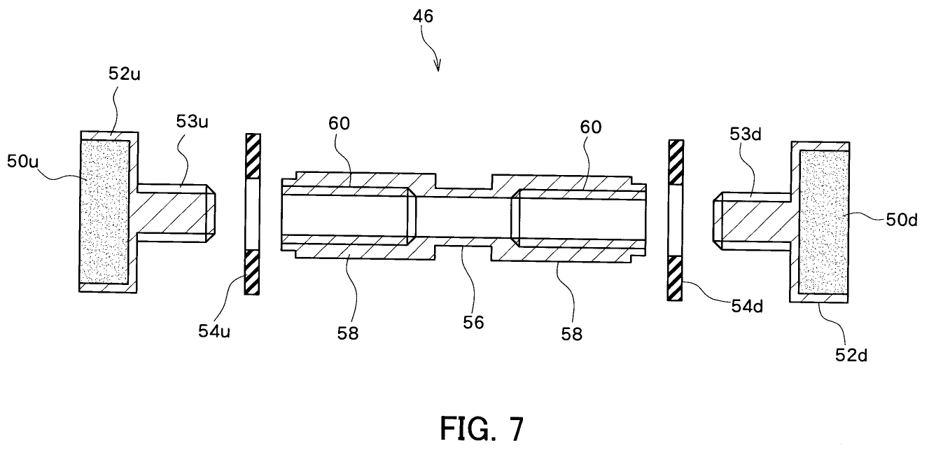

The movable element 14 inserted into the cylinder hole 30 will now be described by reference to FIGS. 2 and 7. FIG. 7 is an exploded cross-sectional view of the movable element 14. The movable element 14 is formed from a shaft 46 inserted into the cylinder hole 30 (to be more exact, the collar 36 fitted to the cylinder hole 30); magnet holders 52u and 52d screw-fastened to both ends of the shaft 46; and movable magnets 50u and 50d held by the magnet holders 52u and 52d, respectively.

The shaft 46 is a shaft member made of a nonmagnetic rigid material, such as SUS303. The shaft 46 is a tubular element made hollow for weight reduction. Therefore, the entirety of the movable element 14 including the shaft 46 can be reduced in weight, and power consumption required for actuating the movable element 14 can be diminished. Internal threads 60 to be screw-engaged with the magnet holders 52 are formed at respective ends of the shaft 46.

The shaft 46 is broadly divided into large-diameter portions 58, each of which has an outer diameter that is slightly smaller than the inner diameter of the collar 36, and a small-diameter portion 56 whose outer diameter is smaller than the large-diameter portion 58. The outer diameter of the small-diameter portion 56 is of the order which enables formation of an air passage space for permitting the passage of air between the small-diameter section and an inner peripheral surface of the collar 36. In the meantime, the large-diameter portions 58 extending from both ends of the small-diameter portion 56 each have an outer diameter that is slightly smaller than the inner diameter of the collar 36. When the shaft is inserted into the collar 36, the large-diameter sections come close to the inner peripheral surface of the collar 36.

When the shaft 46 moves forwardly and rearwardly while being inserted into the cylinder hole 30 and when the small-diameter portion 56 moves to the position where the small-diameter section directly faces the negative pressure inlet 38 and the negative pressure outlet 42, passage of negative-pressure air by way of an air passage space created between the small-diameter portion 56 and the collar 36 is permitted. Concurrently, the positive pressure inlet 40 and the positive pressure outlet 44 are blocked by the large-diameter portions 58 whose outer diameter is slightly smaller than the inner diameter of the collar 36, so that the passage of positive-pressure air is substantially hindered.

When the small-diameter portion 56 moves to the position where the small-diameter section directly faces the positive pressure inlet 40 and the positive pressure outlet 44, passage of positive-pressure air by way of the air passage space created between the small-diameter portion 56 and the collar 36 is permitted. Concurrently, the negative pressure inlet 38 and the negative pressure outlet 42 are blocked by the large-diameter portions 58, so that the passage of negative-pressure air is substantially hindered. Specifically, negative-pressure air and positive-pressure air can be switchably supplied to the nozzle as a result of forward and rearward movements of the shaft 46.

In reality, minute clearance for permitting forward and rearward movements of the shaft 46 exists between the large-diameter portions 58 and the inner peripheral surface of the collar 36. A considerably-trace amount of air leaks by way of the minute clearance. The trace amount of air acts as an air bearing that levitates the shaft 46. Consequently, wearing of the shaft 46 and the collar 36 can be lessened.

A pair of movable magnets; namely, the upper movable magnet 50u and the lower movable magnet 50d (when the movable magnets are not distinguished from each other in relation to the vertical, positional relationship, subscripts “u” and “d” are omitted, and the same also applies to the other members), are fixed to both ends of the shaft 46 by way of the magnet holders 52u, 52d. The respective movable magnets 50 are disc-shaped magnets formed from permanent magnet, such as neodymium magnets. When the movable magnets 50 receive magnetic force from the drive section 16, the movable element 14 moves forwardly and rearwardly, which will be described in detail later. As shown in FIG. 1, the two movable magnets 50 provided at both ends of the shaft 46 are positioned in such a way that the same poles of the magnets oppose each other (N poles oppose each other in the illustrated example).

The magnet holders 52 that hold the movable magnets 50 are made of a nonmagnetic rigid material, such as SUS303C. Circular recesses for housing and holding the movable magnets 50 are formed in upper surfaces of the magnet holders 52. External threads 53 screw-fastened to the shaft 46 are projectingly formed on bottom surfaces of the magnet holders 52 (see FIG. 7). In the present embodiment, both of the two magnet holders 52u and 52d are configured so as to be removable from the shaft 46. At least one of the magnet holders 52u and 52d may be formed integrally with the shaft 46, to thus attempt to curtail the number of components.

As mentioned previously, in the present embodiment, negative-pressure air and positive-pressure air are switchably supplied by means of causing the movable element 14 formed from the shaft 46, and the like, to forwardly and rearwardly move. However, the positions of forward and rearward movements of the movable element 14 are regulated as a result of a bottom surface of the magnet holders 52 contacting an exterior surface of the cylinder 20. From another viewpoint, the bottom surfaces of the magnet holders 52 collide with the exterior surface of the cylinder 20 every time the movable element 14 forwardly and rearwardly moves. In order to diminish physical impact stemming from collision and to prevent infliction of damages to the magnet holders 52 and the cylinder 20, dampers 54 are provided on the respective bottom surfaces of the magnet holders 52. The dampers 54 are disc-shaped members made from a material exhibiting superior nonmagnetic properties and abrasion resistance, such as POM (polyacetal). Through holes that permit the passage of the external threads projecting from the respective bottom surfaces of the magnet holders 52 are opened in the centers of the dampers. Fixing the dampers 54 to the bottom surfaces of the magnet holders 52, thereby lessening physical shock, which would be inflicted on the magnet holders 52 and the cylinder 20 in association with forward and rearward movements of the movable element 14. As a consequence, a reduction in the life of the mechanical valve 10 can be prevented. The dampers 54 act also as spacers that adjust a distance between the cylinder 20 made of a magnetic material and the movable magnets 50, to thus acquire appropriate latch force, which will be described in detail later. The dampers may also be omitted by means of embodying the magnet holders 54 as molded components formed from a material exhibiting a superior damping characteristic, such as POM (polyacetal) and imparting the damper's feature to the magnet holders 54.

The drive section 16 will now be described in detail. As shown in FIG. 1, the drive section 16 includes an electromagnet 62; sensors 68 that detect forward and rearward movements of the shaft 46; a base 70 that holds the electromagnets 62, the sensors 68, and the like; a drive circuit (not shown in FIG. 1) that drives the electromagnets 62; and the like.

The electromagnets 62 are provided such that one electromagnet corresponds to one movable magnet 50 and positioned opposite the corresponding movable magnets 50. Each of the electromagnets 62 is formed from an excitation coil 66 connected to a drive circuit and a stationary magnet 64 acting as a magnetic core of the excitation coil 66. Upon receipt of a current supply from the drive circuit, the excitation coils 66 are excited, to thus move the corresponding (opposing) movable magnets 50 by means of magnetic force resulting from excitation and, by extension, move the shaft 46 coupled to the movable magnets 50.

The stationary magnets 64 are formed from permanent magnet, such as neodymium magnet, and positioned in the centers of the excitation coils 66, respectively. The stationary magnets 64 act as magnetic cores of the excitation coils 66, thereby enhancing the intensity of a magnetic field originating from the excitation coils 66. The stationary magnets 64 are arranged opposite the corresponding movable magnets 50 in such a way that the same poles of the magnets oppose each other (the S poles of the magnets oppose each other in the illustrated embodiment). Therefore, given magnetic repulsive force always arises between the stationary magnet 64 and the movable magnet 50 regardless of the state of magnetic excitation of the excitation coils 66. The magnetic repulsive force developing between the stationary magnet 64 and the movable magnet 50 acts as biasing force that assists movement of the shaft 46. This will also be described in detail.

The two sensors 68 detect progress of forward or rearward movement of the movable element 14. The respective sensors 68 are noncontact optical sensors that radiate detection light on a target and that detect the presence/absence of the target and a distance to the target on the basis of the state of acquired reflected light. The sensors 68 are fixedly positioned at a previously-specified height. Specifically, an upper sensor 68u is placed at a height where the sensor can radiate detection light toward the upper magnet holder 52u when the movable element 14 moves upwardly. Further, a lower sensor 68d is placed at a height where the sensor can radiate detection light toward the lower magnet holder 52d when the movable element 14 moves downwardly. A high-level controller (not shown) determines the movement status of the movable element 14 on the basis of a result of detection performed by the sensors 68 and controls the actuation of the valve 10 in accordance with a result of the determination. Specifically, when the upper sensor 68u can detect the upper magnet holder 52u and the lower sensor 68d cannot detect the lower magnet holder 52d, the high-level controller determines that the movable element 14 has moved upwardly. Conversely, when the upper sensor 68u cannot detect the upper magnet holder 52u and the lower sensor 68d can detect the lower magnet holder 52d, the high-level controller determines that the movable element 14 has moved downwardly.

In many related-art valves, the position of the valve element is alternatively detected by detecting the position of a component of the drive section 16 that actuates the valve element; for instance, the number of rotations of a motor, the position of a transmission component, such as a cam, and the position of an electromagnetic plunger, rather than detecting the position of the valve element. Therefore, it has been difficult to detect a defective in the valve element; for instance, damage to the valve element, a stacking (clogging) of the valve element, and the like. In the meantime, in the present invention, the position of the movable element 14 serving as a valve element is detected directly by means of the sensors 68. Therefore, a defective in the valve element (the movable element 14) itself can be reliably detected. Further, since the position of the valve element that is a control target is detected, a time lag included in a detection result can be reduced, so that more appropriate control becomes possible.

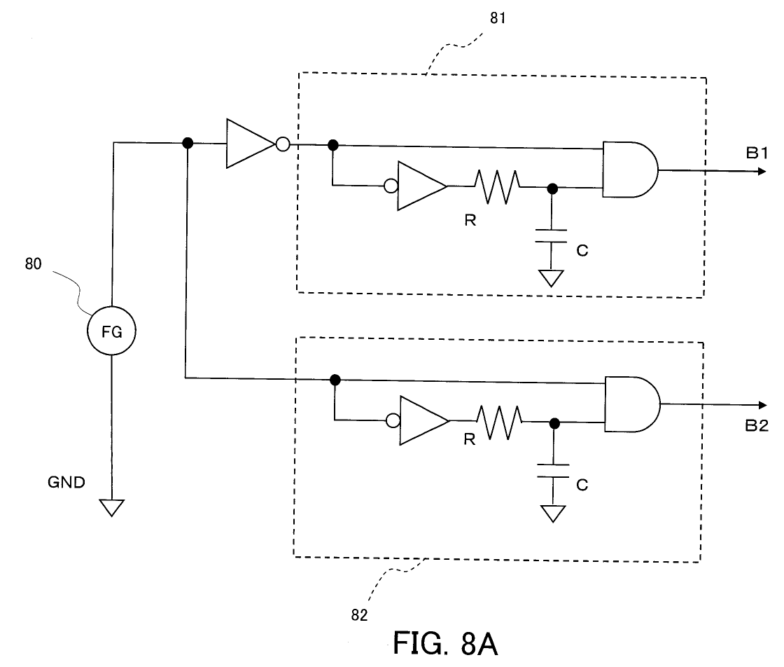

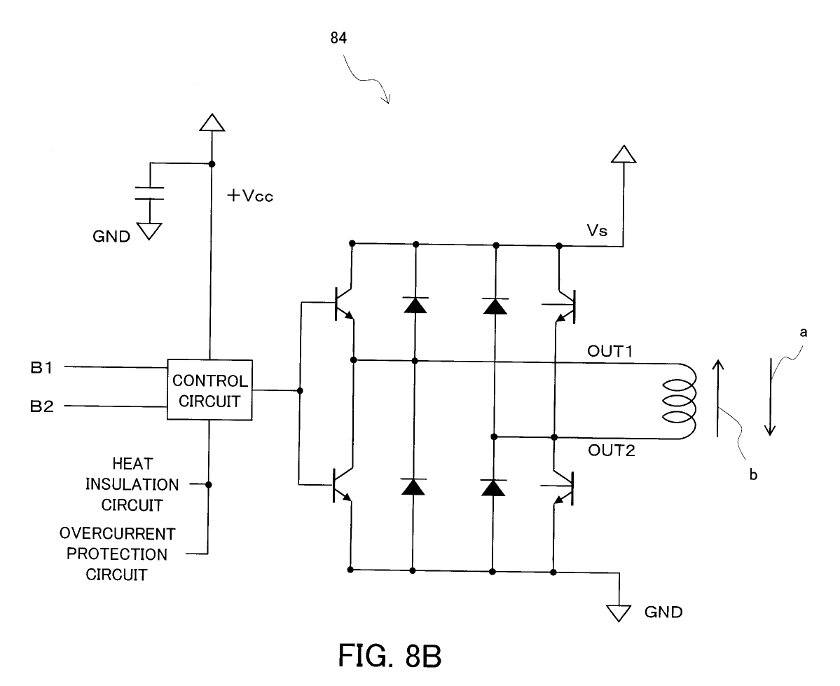

A drive circuit for driving the excitation coil 66 will now be described. FIGS. 8A and 8B are circuit diagrams of a drive circuit connected to the excitation coils 66. As shown in FIG. 8A, a drive signal output from a function generator 80 is output to a terminal B1 by way of a NOT circuit and a first circuit 81. A drive signal (a rectangular pulse signal) is also output to a terminal B2 by way of a second circuit 82. The first circuit 81 and the second circuit 82 have the same configuration and adjust a duty ratio of the thus-input drive signal. Specifically, the first circuit 81 and the second circuit 82 converts a drive signal, which is output from the timing generator 80 and which has a duty ratio of 0.5, into a signal having a duty ratio of the order of 0.02 to 0.06. The signal whose duty ratio has been converted is input to a full-bridge circuit 84 shown in FIG. 8B by way of the terminals B1 and B2. The full-bridge circuit 84 is a general-purpose circuit that is utilized for forward and rearward rotation of a brushed motor and that is distributed in large numbers in the market in an integrated form. The excitation coils 66 are connected to output terminals OUT1 and OUT2 of the full-bridge circuit 84. When a signal of “one” is input to the terminal B1 and when a signal of “zero” is input to the terminal B2, an electric current oriented in the direction of arrow “a” is supplied to the excitation coils 66. Conversely, when the signal of “zero” is input to the terminal B1 and when the signal of “one” is input to the terminal B2, an electric current of arrow “b” is supplied to the excitation coil 66. In the present embodiment, electric currents of opposite directions are supplied to the two excitation coils 66 by use of the drive circuit. Thus, magnetic repulsive force develops between one excitation coil 66 and its corresponding movable magnet 50, and magnetic attractive force develops between the other excitation coil 66 and its corresponding movable magnet 50. When switching between the negative-pressure air and the positive-pressure air is performed, the drive signals input to the terminals B1 and B2 are inverted, to thus reverse the direction of the electric currents flowing into the respective excitation coils 66. In the present embodiment, the respective excitation coils 66 perform push-pull current operation. As mentioned previously, in the present embodiment, the duty ratio of the signal input to the full-bridge circuit 84 is reduced, thereby making a period of time during which the excitation coils 66 are energized shorter than a drive period. Power consumption and the amount of heat generated by the excitation coils 66 are hereby decreased. So long as the amount of current acquired during energization is sufficient, the movable element 14 can be activated without any problems even when energization is momentary. The drive circuit illustrated herein is an example. A circuit of another configuration may also be used, as necessary, so long as the circuit can drive the movable element 14.

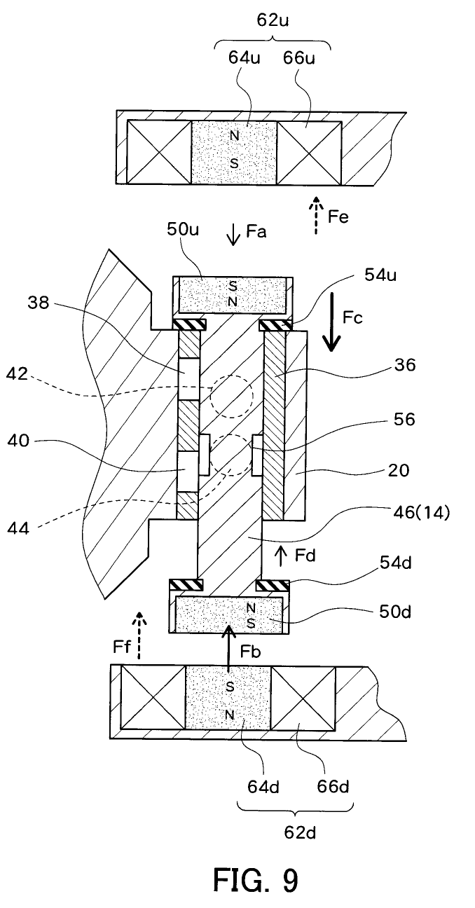

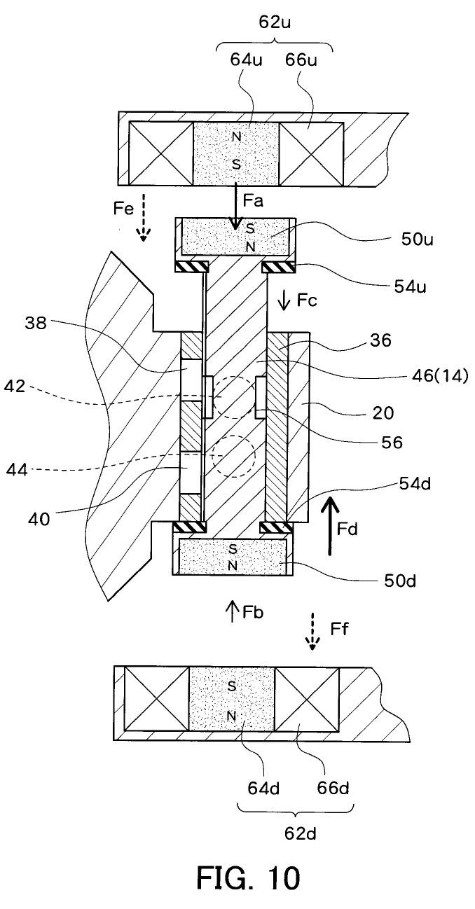

The manner of driving of the mechanical valve 10 will now be described by reference to FIGS. 9 and 10. FIGS. 9 and 10 are cross-sectional views of the principal section of the mechanical valve 10. FIG. 9 shows driving operation of the mechanical valve performed at the time of supply of positive-pressure air. FIG. 10 shows driving operation of the mechanical valve performed at the time of supply of negative-pressure air.

As shown in FIG. 9, when positive-pressure air is supplied, the movable element 14 moves to a position where the small-diameter portion 56 of the shaft 46 directly faces the positive pressure inlet 40 and the positive pressure outlet 44. Consequently, the positive pressure inlet 40 and the positive pressure outlet 44 are opened in a passage space created between the small-diameter portion 56 and the internal peripheral surface of the collar 36. The positive-pressure air entered from the positive pressure inlet 40 is supplied to the nozzle by way of the passage space and the positive pressure outlet 44. Meanwhile, both the negative pressure inlet 38 and the negative pressure outlet 42 are blocked by the large-diameter portions 58 of the shaft 46 at this time, and hence intrusion of negative-pressure air into the cylinder hole 30 is hindered.

Force acting on the movable element 14 during supply of the positive-pressure air will be described. When the movable element 14 moved the lower-limit position, the drive circuit interrupts energization of the exciting coils 66. Consequently, magnetic operation does not arise between the movable magnet 50 and its corresponding energization coil 66 at the time of supply of the positive-pressure air. The force acting on the movable element 14 when energization of the excitation coils 66 is interrupted is represented as indicated by arrows of solid lines in FIG. 9. Specifically, the stationary magnets 64 are permanent magnets that generate magnetic force at all times regardless of the state of energization of the excitation coils 66. The movable magnet 50 corresponding to the stationary magnet 64 is arranged in such a way that the same poles of the magnets oppose each other. Consequently, magnetic repulsive force Fa develops between the upper stationary magnet 64u and the upper movable magnet 50u, and magnetic repulsive force Fb develops between the lower stationary magnet 64d and the lower movable magnet 50d. Since the movable element 14 has moved to the lower position during supply of the positive-pressure air, the distance between upper magnets is greater than the distance between lower magnets. The upper magnetic repulsive force Fa becomes smaller than the lower magnetic repulsive force Fb (Fb>Fa); namely, upward magnetic force having a magnitude (Fb−Fa) acts on the movable element 14 by means of the magnetic repulsive force developing between the movable magnets 50 and the stationary magnets 64. When the movable element 14 is moved upwardly by the upward magnetic force, supply of positive-pressure air cannot be performed continually, which raises a problem.

Accordingly, in the present embodiment, the cylinder 20 (the main body 12) is configured so as to include a magnetic material section (the collar 36). The magnetic attractive force developing between the magnetic material section (the collar 36) of the cylinder 20 and the movable magnets 50 is utilized as latching force for maintaining the state of supply of positive-pressure air. Specifically, when the cylinder 20 is configured so as to include a magnetic material section, magnetic attractive force Fc develops between the upper movable magnet 50u and the cylinder 20, and magnetic attractive force Fd develops between the lower movable magnet 50d and the cylinder 20. At the time of supply of the positive-pressure air, the distance between the upper movable magnet 50u and the cylinder 20 is shorter than the distance between the lower movable magnet 50d and the cylinder 20. Hence, the magnetic attractive force Fc developing on the upper side is greater than the magnetic attractive force Fd developing on the lower side (Fc>Fd). As a consequence, when attention is paid solely to the magnetic attractive forces developing between the movable magnets 50 and the cylinder 20, downward magnetic force having a magnitude (Fc−Fd) arises in the movable element 14. In the present embodiment, magnetic flux densities of the respective magnets and a positional relationship among respective sections; for instance, the thickness of the dampers 54, are regulated in such a way that the magnetic force (Fc−Fd) induced by the magnetic attractive force becomes greater than the magnetic force (Fb−Fa) induced by the magnetic repulsive force. Consequently, at the time of supply of the positive-pressure air, downward force comprehensively acts on the movable element 14, so that there can be maintained the state of supply of the positive-pressure air where the movable element 14 moved downwardly.

Subsequently, there will be described a case where the state of supply of positive-pressure air is switched to a state of supply of negative-pressure air (switching of a state shown in FIG. 9 to a state shown in FIG. 10). In this case, the drive circuit supplies electric currents of opposite directions to the two excitation coils 66u and 66d. Arrows of broken lines shown in FIG. 9 indicate magnetic force stemming from energization. Specifically, when switching the state of supply of positive-pressure air to the state of supply of negative-pressure air, the drive circuit cause an electric current, which increases magnetic repulsive force Fb developing between the lower electromagnet and the lower movable magnet 50d, to flow into the lower excitation coil 66d. From another viewpoint, the drive circuit flows an electric current whose direction causes the lower electromagnet 62d to act as an electromagnet that induces magnetic repulsive force Ff between the lower electromagnet and the lower movable magnet 50d.

In the meantime, the drive circuit supplies the upper excitation coil 66u with an electric current whose direction is opposite to the direction of the electric current flowing into the lower excitation coil 66d. As a consequence, magnetic force Fe that diminishes magnetic repulsive force Fa developing between the upper movable magnet 50u and the upper electromagnet arises in the upper electromagnet 62u. Put another way, as a result of supply of the electric current of an opposite direction, the upper electromagnet 62u acts as an electromagnet that induces the magnetic attractive force Fe between the upper electromagnet and the upper movable magnet 50u.

In addition to the upward magnetic force (Fb+Fd) and the downward magnetic force (Fa+Fc) that have acted on the movable element thus far, upward magnetic force (Fe+Ff) also acts on the movable element 14 by means of a current supply from the drive circuit. At a point in time when the upward magnetic force (Fe+Ff) stemming from supply of an electric current surpasses latching force (Fa+Fc−Fb−Fd), the movable element 14 moves upwardly. Finally, as illustrated in FIG. 10, the lower damper member 54d comes to a halt upon contacting an end face of the cylinder 20.

At this time, the small-diameter portion 56 of the shaft 46 directly faces the negative-pressure inlet 38 and the negative-pressure outlet 42. As a consequence, the negative-pressure inlet 38 and the negative-pressure outlet 42 are opened for the passage space created between the small-diameter portion 56 and the internal peripheral surface of the collar 36. The negative-pressure air entered the negative-pressure inlet 38 is supplied to the nozzle by way of the passage space and the negative-pressure outlet 42. In the meantime, at this time, both the positive-pressure inlet 40 and the positive-pressure outlet 44 are blocked by the large-diameter portions 58 of the shaft 46, so that intrusion of positive-pressure air into the cylinder hole 30 is hindered.

When the state is detected by the sensor 68, the drive circuit interrupts supply of the electric current to the excitation coil 66. The force acting on the movable element 14 at this time is essentially the same as that achieved at the time of supply of positive-pressure air. Specifically, although the downward magnetic force acts on the movable element 14 by means of the magnetic repulsive force Fa developing between the upper movable magnet 50u and the upper stationary magnet 64u, the magnetic attractive force Fd (upward magnetic force) that is equal to or greater than the downward magnetic force develops between the lower movable magnet 50d and the cylinder. Therefore, the movable element 14 continually maintains the state of supply of negative-pressure air.

When the state of supply of negative-pressure air is again switched to the state of supply of positive-pressure air (switching of the state shown in FIG. 10 to the state shown in FIG. 9), all you have to do is to again supply an electric current to the excitation coil 66. Arrows of broken lines in FIG. 10 designate magnetic force stemming from energization. Specifically, in this case, the direction of a supplied electric current is opposite to that of the electric current supplied for performing switching to the state of supply of the negative-pressure air. Namely, an electric current whose direction diminishes the magnetic repulsive force Fb developing between the lower electromagnet and the lower movable magnet 50d is caused to flow into the lower excitation coil 66d. Further, an electric current whose direction increases the magnetic repulsive force Fa developing between the upper electromagnet and the upper movable magnet 50u is caused to flow into the upper excitation coil 66u. As a result, the movable element 14 again moves downwardly, whereupon a shift to the state of supply of positive-pressure air, such as that shown in FIG. 9, arises.

As is evident from the above descriptions, switching between the negative-pressure air and the positive-pressure air is realized by utilization of magnetic force in the present embodiment. Therefore, when compared with the case of utilization a motor, or the like, very high-speed switching becomes possible. Further, a drive force transmission mechanism, such as a cam, is not necessary. Hence, when compared with a case where a motor, or the like, is utilized, the mechanical valve can be miniaturized. Since the mechanical valve has a configuration of switching between negative-pressure air and positive-pressure air by means of forwardly and rearwardly moving the single movable element 14, the mechanical valve can be miniaturized and reduced in terms of the number of components when compared with the valve that causes two rods to move forwardly and rearwardly, such as that described in connection with 9-144911 A.

Incidentally, in the present embodiment, the movable element 14 is driven by use of the excitation coil 66 having the stationary magnet 64 as a magnetic core; namely, a core coil, as is evident from the descriptions provided thus far. There is another conceivable case where an air-core coil is used in lieu of the core coil; namely, where the movable element 14 is driven by use of only the excitation coil 66 while the stationary magnet 64 is omitted. However, in order to achieve the magnetic force sufficient for moving the movable element 14 by means of the air-core coil, a heavy current must be supplied to the air-core coil. Even when a period of energization is shortened, an increase in power consumption will be induced. Moreover, since a heating value increases with an increase in the electric current, a necessity for newly providing a heat-radiation member, such as a heat sink, arises. Consequently, an increase in the size of the valve and an increase in the number of components arise, which in turn raises a problem of an increase in cost. As a matter of course, it is possible to increase magnetic force acting on the movable magnets 50 by means of making an interval between the air-core coil and the movable magnet 50 narrow. However, when an interval between the air-core coil and the movable magnets 50 is excessively narrow, there will also arise a new problem of difficulty being encountered in maintaining the accuracy of assembly of the valve.

In order to avoid such a problem, the excitation coil 66 having a magnetic core is used in the present embodiment. As a result of use of a permanent magnet (the stationary magnet 64) as the magnetic core, magnetic repulsive force developing between the permanent magnet and the movable magnet 50 acts as biasing force. Consequently, even when the amount of electric current supplied to the excitation coil 66 is comparatively small, sufficient drive force can be acquired, and power consumption can be reduced.

In the present embodiment, a permanent magnet is used as a magnetic core. However, an electromagnet may also be used as a magnetic core (the stationary magnets 64), so long as bias force originating from magnetic force can be added. Specifically, the electromagnet formed by wrapping a coil around an iron core may also be positioned opposite the respective movable magnets 50, and the excitation coil 66 may also be wrapped around the electromagnet. When action of magnetic force between the electromagnet and its corresponding movable magnet 50 is not desired, application of an electric current to the coil of the electromagnet may also be interrupted as necessary.

Although the permanent magnet is used as the magnetic core in the present embodiment, the magnetic core may also be embodied as a magnetic pole formed from soft iron or a complex including a magnet for biasing magnetic force and soft iron, and the movable element 14 may also be actuated by changing the drive-side magnetic pole. In this case, when the electromagnets 62 push the movable element 14, the magnetic poles of the electromagnets 62 are changed such that the magnetic poles of the electromagnets 62 and the magnetic poles of the movable magnets 50 repel each other. In contrast, when the electromagnets 62 pull the movable element 14, the magnetic poles of the electromagnets 62 are changed such that the magnetic poles of the electromagnets and the magnetic poles of the movable magnets 50 of the movable element 14 attract each other. Specifically, as shown in FIG. 9, when the movable element 14 is moved downward, the magnetic pole of the upper electromagnet 62u is controlled so as to change to the S pole, thereby bringing a relationship between the magnetic pole of the upper electromagnet 62u and the magnetic pole of the movable magnet 50u of the movable element 14 into S-S. Thus, the upper electromagnet 62u and the movable electromagnet 50u are caused to repel each other. Concurrently, the magnetic pole of the lower electromagnet 62d is controlled so as to change to the N pole, there bringing a relationship between the magnetic pole of the lower electromagnet 62d and the magnetic pole of the movable magnet 50d of the movable element 14 into N-S. Thus, the lower electromagnet 62d is caused to attract the movable magnet 50d. The movable element 14 is moved downward for reasons of changes in the magnetic poles of the electromagnets 62. In the meantime, as shown in FIG. 10, when the movable element 14 is moved upward, the magnetic pole of the upper magnet 62u is controlled so as to change to the N pole, thereby bringing a relationship between the magnetic pole of the upper electromagnet 62u and the magnetic pole of the movable magnet 50u of the movable element into N-S, and the upper electromagnet 62d is caused to attach the movable magnet 50u. Simultaneously, the magnetic pole of the lower magnet 62d is controlled so as to change to the S pole, thereby bringing a relationship between the magnetic pole of the lower electromagnet 62d and the magnetic pole of the movable magnet 50d of the movable element 14 into S-S. Thus, the lower electromagnet 62d and the movable magnet 50d are caused to repel each other. The movable element 14 is moved upward by means of changes in the electromagnets 62. Although the electromagnets 62 have soft iron magnetic poles in the present embodiment, the excitation coil itself is an air-core coil, the magnetic circuit also changes to an open magnetic circuit. Therefore, setting of a resonance circuit in the drive circuit is facilitated, and power consumption can be reduced, which in turn reduces heat generation.

In the above descriptions, only the magnetic force acting on the respective portions and sections has been described. However, gravity also acts on the movable element 14 that moves in the vertical direction. As a consequence, when compared with the case where the movable element moves downwardly, greater force is achieved when the movable element moves upwardly. Accordingly, in order to absorb the difference between the forces required for the movement resultant from gravity, the intensity of the magnet positioned at an upper location and the intensity of the magnet positioned at a lower location may also be caused to differ from each other. In the present patent specification, the descriptions have been provided by citing, as an example, the configuration of the mechanical valve utilized for the electronic component automatic placement machine. However, as a matter of course, the present invention may also be applied to a mechanical valve incorporated in another apparatus.

Moreover, the type of air to be switchably supplied is not limited to negative-pressure air or positive-pressure air also.

What is claimed is:

1. A mechanical valve comprising:
a cylinder having a first air opening for permitting passage of first air and a second air opening for permitting passage of second air, both of which are formed in an internal peripheral surface of the cylinder;
a shaft that is inserted into the cylinder so as to be movable in forward and rearward directions, that opens the first air opening and closes the second air opening by means of forward movement, and that opens the second air opening and closes the first air opening by means of rearward movement; and
drive means that moves the shaft forwardly and rearwardly, wherein
the drive means includes
a pair of movable magnets that are formed from permanent magnets and that are provided at both ends of the shaft;
a pair of electromagnets that are provided opposite the respective movable magnets and that forwardly and rearwardly moves the shaft by means of magnetic force developing between the electromagnet and a corresponding movable magnet when the electromagnets are excited; and
a drive circuit for exciting the pair of electromagnets.

2. The mechanical valve defined in claim 1, wherein a magnetic core of each of the electromagnets is a magnet that induces magnetic repulsive force between the magnetic core and an opposing movable magnet.

3. The mechanical valve defined in claim 1, wherein a magnetic core of each of the electromagnets is a magnetic pole formed from soft iron.

4. The mechanical valve defined in claim 1, wherein a magnetic core of each of the electromagnets is a magnetic pole formed from a composite including soft iron and a magnet for biasing magnetic force.

5. The mechanical valve defined in claim 1, wherein a magnetic material area, which is formed from a magnetic material and which works as a latch mechanism for regulating movement of the movable magnet by exhibiting magnetic attractive force between the movable magnet and the magnetic material area, is provided in the vicinities of at least both ends of the cylinder.

6. The mechanical valve defined in claim 1, wherein the inside of the shaft is hollow.

7. The mechanical valve defined in claim 1, wherein the first air opening includes a first air inlet for permitting entry of the first air and a first air outlet that is aligned with the first air inlet along a circumferential direction and that permits discharge of the first air;
the second air opening includes a second air inlet for permitting entry of the second air and a second air outlet that is aligned with the second air inlet along the circumferential direction and that permits external discharge of the second air; and
the shaft includes
large-diameter portions that are essentially identical in size with an internal diameter of the cylinder, that close the second air inlet and the second air outlet at the time of forward movement of the shaft, and that close the first air inlet and the first air outlet at the time of rearward movement of the shaft; and
a small-diameter portion that creates passage space for permitting passage of air between an internal peripheral surface of the cylinder and the small-diameter portion, that opens the first air inlet and the first air outlet at the time of forward movement of the shaft, and that opens the second air inlet and the second air outlet at the time of rearward movement of the shaft.
